(19) United States
(12) Patent Application Publication
(10) Pub. No.: US 2015/0308360 A1
(43) Pub. Date: Oct. 29, 2015

(54) Method For Determining A Cylinder Pressure-Crankshaft Position Assignment For An Internal Combustion Engine

(71) Applicant: MAN DIESEL & TURBO SE, Augsburg (DE)

(72) Inventors: Alexander KNAFL, Augsburg (DE); Phillipp HENSCHEN, Kissing (DE); Paul HAGL, Augsburg (DE); Heidi GRUBER, München (DE); Markus BAUER, Augsburg (DE)

(21) Appl. No.: 14/649,499

(22) PCT Filed: Dec. 6, 2013
(86) PCT No.: PCT/EP2013/075811

§ 371 Date: Jun. 3, 2015

(30) Foreign Application Priority Data
Dec. 6, 2012 (DE) 10 2012 023 834.7

(51) Int. Cl. F02D 41/00; G01B 21/16; G01M 15/05; F02D 35/02

(52) U.S. Cl. CPC F02D 41/009; F02D 35/023; G01B 21/16; G01M 15/05

(57) ABSTRACT

A method for determining a cylinder pressure-crankshaft position association for an internal combustion engine, including metrological detection of the crankshaft angle; metrological detection of the cylinder pressure; calculation of a cylinder volume as a function of the crankshaft angle; determination of a curve for the logarithmic cylinder pressure over the logarithmic cylinder volume as a function of the crankshaft angle; analysis of the curve, and determination of an offset value for the crankshaft angle for determining a temporally exact cylinder pressure-crankshaft position association.

### CROSS-REFERENCE TO RELATED APPLICATIONS

This is a U.S. national stage of application No. PCT/EP2013/075811, filed on Dec. 6, 2013. Priority is claimed on German Application No. DE102012023834.7, filed Dec. 6, 2012, the content of which is incorporated herein by reference.

### BACKGROUND OF THE INVENTION

### Field of the Invention

The invention is directed to a method for determining a cylinder pressure-crankshaft position association for an internal combustion engine.

### SUMMARY OF THE INVENTION

To Control the operation of an internal combustion engine, it is advantageous to know an exact temporal association of the cylinder pressure with a crankshaft position or crankshaft angle. It has been difficult heretofore to determine such a cylinder pressure-crankshaft position association.

One object of the invention is providing a novel method for determining a cylinder pressure-crankshaft position association for an internal combustion engine.

The method includes the following: metrological detection of a crankshaft angle; metrological detection of a cylinder pressure; calculation of a cylinder volume as a function of the crankshaft angle; determination of a curve for logarithmic cylinder pressure over the logarithmic cylinder volume as a function of the crankshaft angle; analysis of the curve; and determination of an offset value for the crankshaft angle for determining a temporally exact cylinder pressure-crankshaft position association.

One embodiment of the invention provides an automatic determination of the cylinder pressure-crankshaft position association for cylinders of an internal combustion engine using simple means and with high accuracy. The method can be carried out automatically in internal combustion engines, specifically in fired operation as well as in non-fired, towed operation of an internal combustion engine. According to one embodiment of the invention, the crankshaft angle and the cylinder pressure are metrologically detected. The cylinder volume is calculated from the crankshaft angle, and a curve is determined from the calculated cylinder volume, the measured crankshaft angle and the measured cylinder pressure for the logarithmic cylinder pressure over the logarithmic cylinder volume as a function of crankshaft angle. This curve is analyzed and, depending on the analysis, an offset value for the crankshaft angle is determined for determining the temporally exact cylinder pressure-crankshaft position association.

Preferably, the curve in the region of a cylinder reversal point is analyzed for determining the offset value. In so doing, the curve in the region of a bottom cylinder reversal point or in the region of a top cylinder reversal point can be analyzed for determining the offset value. The analysis of the curve in the region of the cylinder reversal point is particularly advantageous.

When an intersection of curve segments of the curve is determined in the region of the cylinder reversal point, it is concluded that a cylinder pressure signal is retarded in relation to the crankshaft angle signal, and an offset value for compensating this displacement is determined as a function of the surface area between the curve segments of the curve in the region of the cylinder reversal point. On the other hand, when a non-intersection of curve segments of the curve is determined in the region of the cylinder reversal point, it is concluded that a cylinder pressure signal is premature in relation to the crankshaft angle signal, and an offset value for compensating this displacement is determined as a function of the surface area between the curve segments of the curve in the region of the cylinder reversal point.

### BRIEF DESCRIPTION OF THE DRAWINGS

Without limiting generality, embodiment examples of the invention are explained more fully with reference to the drawings. In the drawings:

FIG. 1 is a curve for determining an offset value for the crankshaft angle for determining exact cylinder pressure-crankshaft position association; and

FIGS. 2a to 2c are alternative details of the curve from FIG. 1.

### DETAILED DESCRIPTION OF THE PRESENTLY PREFERRED EMBODIMENTS

The present invention is directed to a method for automatically determining a cylinder pressure-crankshaft position association for the cylinders of an internal combustion engine. The method according to one embodiment of the invention can be implemented automatically in fired operation of an internal combustion engine as well as in non-fired, towed operation of an internal combustion engine.

For automatic implementation of the method according to one embodiment of the invention, a crankshaft angle is metrologically detected progressively, for example, by a rotary encoder. Further, the cylinder pressure is automatically detected by a pressure sensor, particularly as a function of the crankshaft angle. The cylinder volume of the respective cylinder of the internal combustion engine is determined from the metrologically detected crankshaft angle.

A curve is determined from the metrologically detected cylinder pressure and from the cylinder volume calculated from the metrologically detected crankshaft angle for the logarithmic cylinder pressure over the logarithmic cylinder volume as a function of crankshaft angle.

This curve is analyzed and an offset value for the crankshaft angle is determined from the curve for determining the temporally exact cylinder pressure-crankshaft position association.

The above steps of the method according to embodiment of the invention proceed fully automatically such that the measurement values of crankshaft angle and cylinder pressure are provided by the corresponding sensors of an engine control device which then calculates the cylinder volume, determines the curve, and automatically analyzes the curve for determining the offset value.

The analysis of the curve, namely, the curve of the logarithmic cylinder pressure over the logarithmic cylinder volume as a function of the crankshaft angle, is preferably carried out in the region of a cylinder reversal point, namely, either in the region of the bottom cylinder reversal point, or bottom dead center, or in the region of the top cylinder reversal point, or top dead center, of a cylinder piston movement of the respective cylinder of the internal combustion engine.

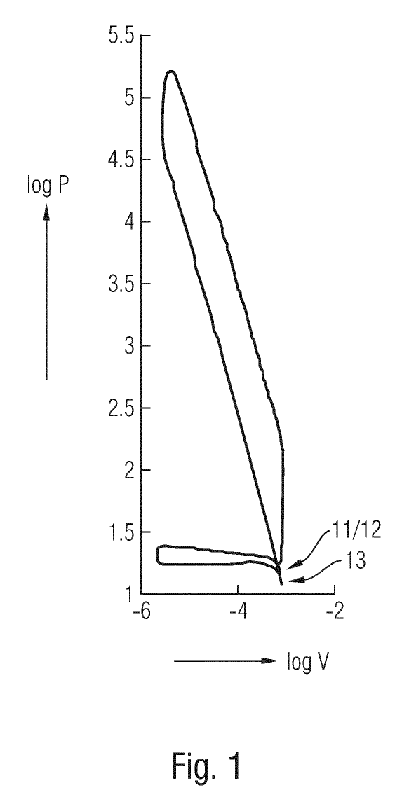

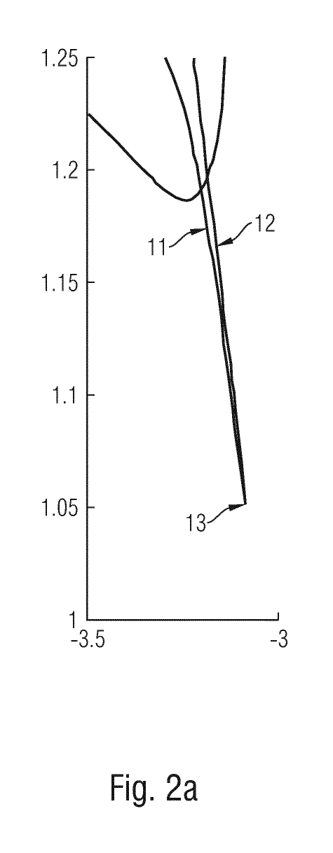

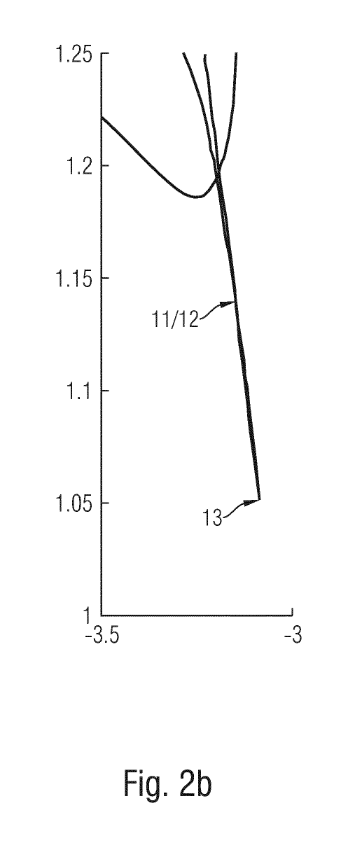

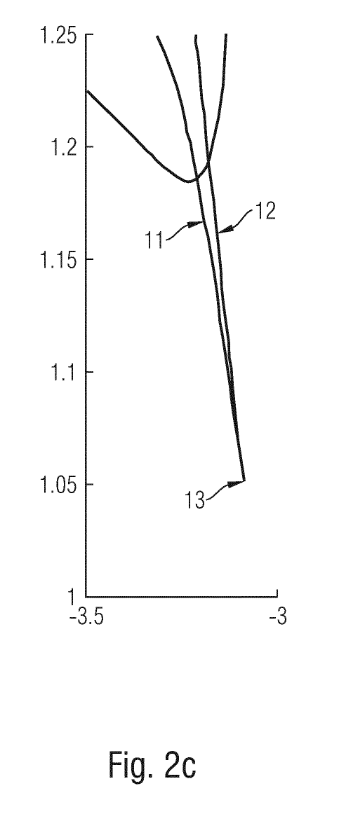

FIG. 1 shows in a highly schematic manner a curve, determined in the automatic implementation of the method for logarithmic cylinder pressure log p over logarithmic cylinder volume log V as a function of the crankshaft angle. In FIG. 1, the logarithmic cylinder pressure log p is plotted over the logarithmic cylinder volume log V for two complete revolutions of the crankshaft, i.e., over 720° of the crankshaft angle. Accordingly, the diagram in FIG. 1 includes the combustion process and a gas exchange in the respective cylinder of the internal combustion engine. FIGS. 2a, 2b and 2c show different, alternative details of the diagram in FIG. 1 in the region of the bottom reversal point, or bottom dead center, of the cylinder piston movement of the respective cylinder.

In the region of the bottom reversal point, or bottom dead center, of the cylinder piston movement of the respective cylinder, the curve in FIG. 1 and in FIGS. 2a, 2b, 2c, respectively, is characterized by curve segments 11 and 12 which converge at a point 13 representing an inflection point in the corresponding curve.

According to embodiment of the invention, the curve in the region of this reversal point 13 is analyzed, namely in such a way that when an intersection of curve segments 11 and 12 of the curve is determined (see FIG. 2b) in the region of the cylinder reversal point 13, it is concluded that a cylinder pressure signal is retarded in relation to the crankshaft angle signal, whereas when a non-intersection of curve segments 11 and 12 of the curve is determined (see FIG. 2c) in the region of the cylinder reversal point 13, it is concluded that a cylinder pressure signal is premature in relation to the crankshaft angle signal.

Further, a surface area between the curve segments 11 and 12 of the curve is determined in the region of the reversal point 13, and the offset value for compensating the determined temporal displacement between the cylinder pressure signal and the crankshaft angle signal is determined as a function of the surface area. The larger this surface area, the larger the resulting offset value. The offset value is preferably iteratively determined in such a way that the surface area between the curve segments 11 and 12 of the curve in the region of the cylinder reversal point is minimal. This is the case, for example, in the diagram in FIG. 2a.

The entire process can be carried out continuously and automatically in fired or non-fired operation of an internal combustion engine. Accordingly, an exact temporal association of the cylinder pressure with the crankshaft angle can be determined entirely automatically during operation in order to control or adjust the operation of the internal combustion engine depending on this association.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. A method for determining a cylinder pressure-crankshaft position association for an internal combustion engine, comprising:
metrological detection of a crankshaft angle;
metrological detection of a cylinder pressure;
calculating of a cylinder volume based at least in part on the crankshaft angle;
determining of a curve for a logarithmic cylinder pressure over a logarithmic cylinder volume based at least in part on the crankshaft angle;
analyzing the curve;
determining of an offset value for the crankshaft angle for determining a temporal cylinder pressure-crankshaft position association;
concluding that a cylinder pressure signal is retarded in relation to a crankshaft angle signal when an intersection of curve segments of the curve is determined in a region of a cylinder reversal point; and
determining an offset value for compensating displacement is determined as a function of a surface area between the curve segments of the curve in the region of the cylinder reversal point.

10. The method according to claim 9, wherein the determination of the cylinder pressure-crankshaft position association for the internal combustion engine is carried out automatically in fired operation of the internal combustion engine.

11. The method according to claim 9, wherein the determination of the cylinder pressure-crankshaft position association for the internal combustion engine is carried out automatically in towed operation of the internal combustion engine.

12. The method according to claim 9, further comprising analyzing the curve in the region of the cylinder reversal point to determine the offset value.

13. The method according to claim 12, wherein the curve in the region of a bottom cylinder reversal point is analyzed to determine the offset value.

14. The method according to claim 12, wherein the curve in the region of a top cylinder reversal point is analyzed to determine the offset value.

15. The method according to claim 12, further comprising:
concluding that a cylinder pressure signal is premature in relation to the crankshaft angle signal when a non-intersection of curve segments of the curve is determined in the region of the cylinder reversal point; and
determining an offset value for compensating displacement as a function of the surface area between the curve segments of the curve in the region of the cylinder reversal point.
